(19) United States
(12) Patent Application Publication
(10) Pub. No.: US 2026/0330980 A1
(43) Pub. Date: Oct. 22, 2026

(54) AERIAL VEHICLE CONTROL DEVICE AND METHOD

(71) Applicant: Hitachi, Ltd., Tokyo (JP)

(72) Inventor: Nobuyasu KANEKAWA, Tokyo (JP)

(73) Assignee: Hitachi, Ltd., Tokyo (JP)

(21) Appl. No.: 19/114,072

(22) PCT Filed: Oct. 24, 2023
(86) PCT No.: PCT/JP2023/038323

§ 371 Date: Mar. 21, 2025

(30) Foreign Application Priority Data
Nov. 29, 2022 (JP) 2022-189957

(51) Int. Cl. G08G 5/34; G08G 5/55; G08G 5/59; G08G 5/80

(52) U.S. Cl. CPC G08G 5/34; G08G 5/55; G08G 5/59; G08G 5/80

(57) ABSTRACT

The present invention addresses the problem of achieving safer flight control of an aerial vehicle while suppressing soaring costs. In order to achieve the above-mentioned purpose, an aerial vehicle control device 100 configured according to the present invention, which performs flight control of an aerial vehicle 200, includes: a flight planning unit 110 that acquires flight-related information indicating conditions regarding the flight of the aerial vehicle 200, identifies a flight continuation level indicating the flight capability of the aerial vehicle 200 according to the flight-related information, identifies a flight-related restriction level for flight airspace corresponding to the flight continuation level, identifies a flyable area satisfying the restriction level, and creates a flight plan including a flight path for the aerial vehicle, using the flyable area; and a guidance control unit 130 that performs flight control of the aerial vehicle using the flight plan.

### TECHNICAL FIELD

The present invention relates to an aerial vehicle control device and method for controlling an aerial vehicle using a flight plan for the aerial vehicle.

### BACKGROUND ART

Currently, technologies for controlling aerial vehicles, for example, unmanned aerial vehicles such as drones, have been proposed. Furthermore, the flight areas of aerial vehicles are strictly restricted, but in recent years there has been a trend toward relaxing these restrictions. In order to relax flight area restrictions on aerial vehicles while ensuring safety, it is important to improve the reliability of aerial vehicles in flight.

With regard to this improvement in reliability, Patent Literature 1 has been proposed. Patent Literature 1 discloses a method in which in order to enable an aerial vehicle to land safely short of the destination, the flight range of the aerial vehicle 20 is calculated from the remaining battery power, and then an information generation unit 280 selects, from among a plurality of candidate landing sites stored by an information storage unit 270, a candidate landing site located within the flight range (or a value obtained by multiplying the flight range by a predetermined coefficient less than 1) from the current position calculated by a control unit 260, as the site where the aerial vehicle 20 should land.

### CITATION LIST

### Patent Literature

Patent Literature 1: Japanese Unexamined Patent Application Publication No. 2020-056694

### SUMMARY OF INVENTION

### Technical Problem

According to Patent Literature 1, when the remaining battery power is low, the aerial vehicle can be safely landed short of the destination, but it is very difficult to respond to all the sudden failures that occur in the airframe. It is extremely difficult to respond to all of these failures, and even if it were to be attempted, it could lead to higher costs for the aerial vehicle and make its configuration more complicated. Furthermore, relaxing regulations without improving the reliability of the airframe of the aerial vehicle will increase the risk of accidents, and accordingly it is an object of the present invention to achieve safer flight control of aerial vehicles while preventing the costs from rising.

### Solution to Problem

In order to achieve the above-mentioned object, the present invention creates a flight plan including a flight route that satisfies an airspace restriction level according to a flight continuation level that indicates the flight capability of an aerial vehicle. More specifically, the present invention provides an aerial vehicle control device for controlling flight of an aerial vehicle. The aerial vehicle control device includes: a flight planning unit; and a guidance control unit. The flight planning unit acquires flight-related information indicating conditions related to the flight of the aerial vehicle, identifies a flight continuation level indicating a flight capability of the aerial vehicle according to the flight-related information, identifies a restriction level for flight in an airspace corresponding to the flight continuation level, identifies a flyable area that satisfies the restriction level, and creates a flight plan including a flight route for the aerial vehicle, using the flyable area. The guidance control unit controls the flight of the aerial vehicle using the flight plan.

### Advantageous Effects of Invention

According to the present invention, it is possible to achieve safer flight control of aerial vehicles while preventing the costs from rising.

### BRIEF DESCRIPTION OF DRAWINGS

FIG. 1 is a system configuration diagram including an aerial vehicle control device 100 according to one embodiment of the present invention.

FIG. 2 is a functional block diagram of the aerial vehicle control device 100 according to one embodiment of the present invention.

FIG. 3 illustrates an airspace divided by a plurality of voxels and its flight route according to a first embodiment.

FIG. 4 is a flowchart illustrating flight control processing according to the first embodiment.

FIG. 5 illustrates a flight plan 330 according to the first embodiment.

FIG. 6 illustrates an airspace divided by corridors and its flight route according to a second embodiment.

FIG. 7 is the flight plan 330 according to the second embodiment.

FIG. 8 is a schematic diagram of flyable area information 310 according to a third embodiment.

FIG. 9 illustrates a procedure for identifying a flight route using the flyable area information 310 according to the third embodiment.

FIG. 10 illustrates flight continuation level information 320 with three flight continuation levels according to a fourth embodiment.

FIG. 11 illustrates the flight continuation level information 320 with three flight continuation levels according to the fourth embodiment.

FIG. 12 illustrates the flyable area information 310 with three airspace restriction levels according to the fourth embodiment.

FIG. 13 illustrates the flight continuation level information 320 with four flight continuation levels according to the fourth embodiment.

FIG. 14 illustrates the flyable area information 310 with four airspace restriction levels according to the fourth embodiment.

FIG. 15 is a first graph illustrating the relationship between lift and failure occurrence, as well as the possibility of continued flight, according to the fourth embodiment.

FIG. 16 is a second graph illustrating the relationship between lift and failure occurrence, as well as the possibility of continued flight, according to the fourth embodiment.

FIG. 17 is a third graph illustrating the relationship between lift and failure occurrence, as well as the possibility of continued flight, according to the fourth embodiment.

FIG. 18 is a fourth graph illustrating the relationship between lift and failure occurrence, as well as the possibility of continued flight, according to the fourth embodiment.

FIG. 19 is a second graph illustrating the relationship between lift and failure occurrence, as well as the possibility of continued flight, according to the fourth embodiment.

FIG. 20 illustrates the flight continuation level information 320, which includes flight continuation levels according to the failure rates in the airframe of an aerial vehicle 200 in a fifth embodiment.

FIG. 21 illustrates the flight continuation level information 320, which indicates flight continuation levels according to the failure rates in the airframe of the aerial vehicle 200 in the fifth embodiment.

FIG. 22 illustrates the redundant aerial vehicle 200 according to the fifth embodiment.

FIG. 23 illustrates the flight continuation level information 320, which indicates flight continuation levels according to the flight capabilities and failure rates in the airframe of the aerial vehicle 200 in the fifth embodiment.

FIG. 24 illustrates the flight continuation level information 320, which indicates flight continuation levels according to the flight capabilities, failure rates, and security levels in the airframe of the aerial vehicle 200 in the fifth embodiment.

FIG. 25 illustrates a security level table according to the fifth embodiment.

FIG. 26 illustrates the flyable area information 310 according to the fifth embodiment.

FIG. 27 illustrates the concept of the flight continuation level information 320 taking into account the effects of wind according to a sixth embodiment.

FIG. 28 illustrates the flight continuation level information 320 taking into account the effects of wind on the aerial vehicle 200 according to the sixth embodiment.

FIG. 29 illustrates the flight continuation level information 320 taking into account the airframe weight of the aerial vehicle 200 according to the sixth embodiment.

FIG. 30 is a system configuration diagram of an aerial vehicle control system including an implementation example of the aerial vehicle control device 100 according to a seventh embodiment.

### DESCRIPTION OF EMBODIMENTS

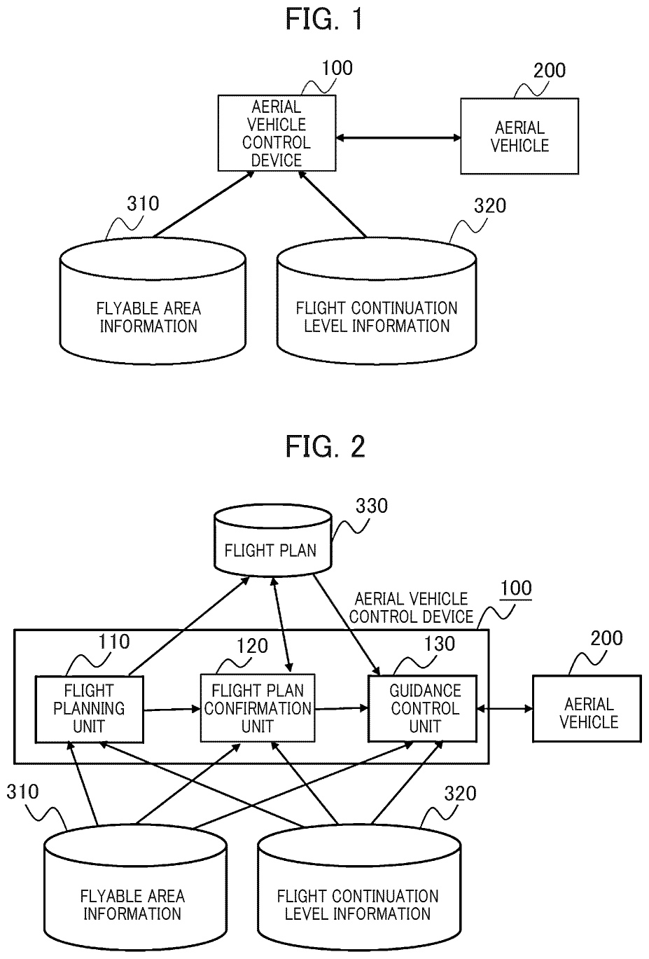

Hereinafter, one embodiment of the present invention will be described with reference to the accompanying drawings. First, FIG. 1 is a system configuration diagram including an aerial vehicle control device 100 according to the present embodiment. In FIG. 1, the aerial vehicle control device 100 controls an aerial vehicle 200 using flyable area information 310 and flight continuation level information 320. More specifically, the aerial vehicle control device 100 uses the flyable area information 310 and the flight continuation level information 320 to create a flight plan 330 including a flight route for the aerial vehicle 200, approves and registers the flight route, and guides and controls the aerial vehicle 200 according to the flight route. For this purpose, the aerial vehicle control device 100 includes a flight planning unit 110, a flight plan confirmation unit 120, and a guidance control unit 130, as illustrated in the functional block diagram of FIG. 2.

Furthermore, the aerial vehicle control device 100 includes an input unit and an output unit that input and output various information and signals. Note that these may be achieved as an input-output unit and a communication unit. Furthermore, the aerial vehicle control device 100 may have a storage unit that stores the flyable area information 310, the flight continuation level information 320, and the flight plan 330, or may be configured to be connected thereto.

First, the flight planning unit 110 uses the flyable area information 310 and the flight continuation level information 320 according to flight-related information indicating conditions related to the flight of the aerial vehicle, to identify a flight route from the start point of the flight to the destination, and create the flight plan 330 that includes this flight route.

In addition, the flight plan confirmation unit 120 confirms the created flight plan 330. For this purpose, the flight plan confirmation unit 120 performs approval processing on the created flight plan 330, and stores the approved flight plan 330 in the storage unit.

In addition, the guidance control unit 130 performs flight control for the aerial vehicle 200 using the created flight plan 330. For this purpose, for example, the guidance control unit 130 creates control signals for flight control and outputs the control signals to the aerial vehicle 200. As a result, the aerial vehicle 200 flies according to the flight plan 330.

This concludes the description of the present embodiment, and examples of more specific forms of the present invention will now be described.

### First Embodiment

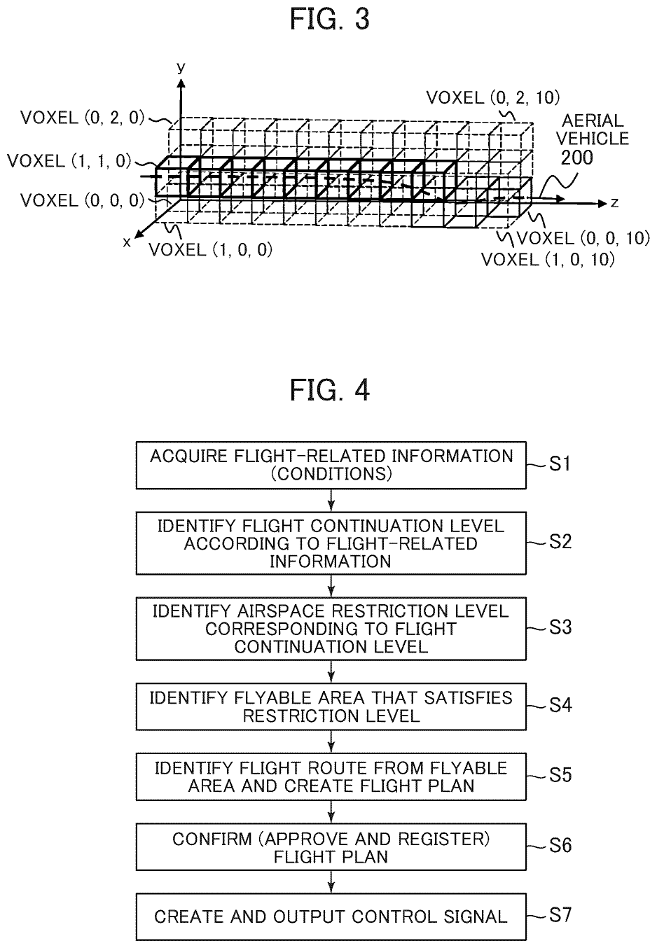

In a first embodiment, a flight route is identified in an airspace divided into a plurality of voxels. FIG. 3 illustrates the airspace divided by the plurality of voxels and its flight route according to the first embodiment. As illustrated in FIG. 3, the aerial vehicle 200 flies from left to right in the drawing. That is, the aerial vehicle 200 flies from voxel (1, 1, 0) through each voxel (1, 1, z) in the direction on the z-axis. Therefore, the flight route can be represented as a set of voxels occupied by the aerial vehicle 200 over time. In the first embodiment, a flight route is identified as a set of voxels occupied by the aerial vehicle 200, and the flight plan 330 including this flight route is created. The processing flow of the present embodiment will be described below. Note that this processing flow is common to a second embodiment and subsequent embodiments.

FIG. 4 is a flowchart illustrating flight control processing according to the first embodiment. First, in step S1, the input unit of the aerial vehicle control device 100 acquires flight-related information indicating the conditions related to the flight of the aerial vehicle 200. Examples of the flight-related information include remaining fuel and battery levels, weight, and weather conditions. In addition, the input unit may accept flight-related information input by a user, or may read flight-related information stored in the storage unit.

Furthermore, in step S2, the flight planning unit 110 identifies, from the flight continuation level information 320, a flight continuation level according to the flight-related information acquired in step S1. Here, the flight continuation level information 320 indicates flight capability, which is the content of flight that the aerial vehicle is capable of, for each flight continuation level. Therefore, in step S2, the flight planning unit 110 searches for the flight continuation level information 320 including the flight capability corresponding to the flight-related information, and identifies the flight continuation level indicated by the flight continuation level information 320. Note that in the present embodiment and in third and fourth embodiments described later, a multi-level flight continuation level with three or more levels is used as the flight continuation level.

Furthermore, in step S3, the flight planning unit 110 identifies, from the flyable area information 310, an airspace restriction level corresponding to the flight continuation level identified in step S2. Here, the flyable area information 310 indicates, for each restriction level, the content of flight restrictions in the positional conditions of the airspace. Therefore, the stricter the restriction level (for example, the larger the numerical value), the higher the flight continuation level, that is, the flight capability, is required. Thus, in the present embodiment, the flight continuation level and the restriction level have a correspondence relationship. For example, if the flight continuation level and the restriction level have the same value, it can be determined that there is a correspondence. Therefore, the flight continuation level and the restriction level desirably include the same levels. Note that the positional conditions of the airspace indicate the distance and relative position from an object such as an important facility.

Therefore, in this step, the flight planning unit 110 uses this correspondence to identify the restriction level that corresponds to the flight continuation level, for example, the restriction level that has the same value as the flight continuation level.

Furthermore, in step S4, the flight planning unit 110 uses the flyable area information 310 to identify a flyable area that satisfies the restriction level identified in step S3. Here, the flyable area that satisfies the restriction level refers to being composed of unit airspaces in which the aerial vehicle 200 can fly and which have a restriction level that has a predetermined relationship with the restriction level identified in step S3. In addition, the predetermined relationship includes a restriction level being equal to or lower than the restriction level identified in step S3, in other words, being relaxed.

Furthermore, in the first embodiment, the airspace is divided into the plurality of voxels. Therefore, the flight planning unit 110 identifies the positional conditions of each voxel in the target airspace. The flight planning unit 110 also identifies each restriction level corresponding to the identified positional conditions using the flyable area information 310. The flight planning unit 110 also extracts the restriction level that is equal to or lower than the restriction level identified in step S3 from among the identified restriction levels. As a result, the flight planning unit 110 extracts voxels with a more relaxed restriction level than the restriction level identified in step S3.

Furthermore, in step S5, the flight planning unit 110 identifies a flight route by combining the extracted voxels, that is, the flyable areas. For this purpose, the flight planning unit 110 identifies continuous or adjacent voxels from the departure position to the arrival position included in the flight-related information among the extracted voxels, and identifies a candidate flight route composed of these voxels. Then, if there are a plurality of candidate flight routes, the flight planning unit 110 evaluates these candidate flight routes to identify a flight route. For this evaluation, short distances, minimum restriction levels, or a combination of these can be used as conditions. Here, when using a restriction level for this evaluation, a representative value such as the sum of the restriction levels of each voxel constituting the flight route, that is, each unit airspace, is used.

Furthermore, if there are no candidate flight routes, the flight planning unit 110 causes the output unit to output a message indicating that the flight is not possible, and terminates this processing. The flight planning unit 110 may also cause the output unit to output information to prompt the user to create a flight plan.

Then, in this step, the flight planning unit 110 performs processing such as adding the passing time and identification information that identifies the target aerial vehicle 200 to each voxel of the identified flight route, and creates the flight plan 330.

Furthermore, in step S6, the flight plan confirmation unit 120 confirms the flight plan created in step S5. For this purpose, the flight plan confirmation unit 120 causes the output unit to output the flight plan created in step S5. Then, if the input unit receives an approval input from the user, the flight plan confirmation unit 120 determines that the created flight plan 330 has been approved. Then the flight plan confirmation unit 120 registers the approved flight plan 330 in the storage unit.

Furthermore, in step S7, the guidance control unit 130 creates a control signal according to the flight plan 330 determined in step S6. Then the guidance control unit 130 outputs this control signal to the aerial vehicle 200 via the output unit. As a result, the aerial vehicle 200 flies according to the flight plan 330. In addition, the guidance control unit 130 executes the processing so that the flight is carried out during the passing time (including the departure time) included in the flight plan 330.

Here, with regard to identifying the flight route or creating the flight plan in this processing flow, a plurality of flight routes or flight plans may be identified and created in advance, and the flight plan confirmation unit 120 or the guidance control unit 130 may select from among these the one that corresponds to the aerial vehicle 200 to be controlled. Note that the flight plan confirmation unit 120 can use the evaluation method of step S5, such as the use of restriction levels, for this selection.

Alternatively, the flight planning unit 110 may identify or create a flight route or flight plan for each flight of the aerial vehicle 200. Further, the flight planning unit 110 may identify or create a plurality of flight routes or flight plans in advance, and if there is no flight route or flight plan corresponding to the aerial vehicle 200 to be controlled, a new one may be identified or created. This concludes the description of FIG. 4, and the flight plan 330 created in this processing flow will be described below.

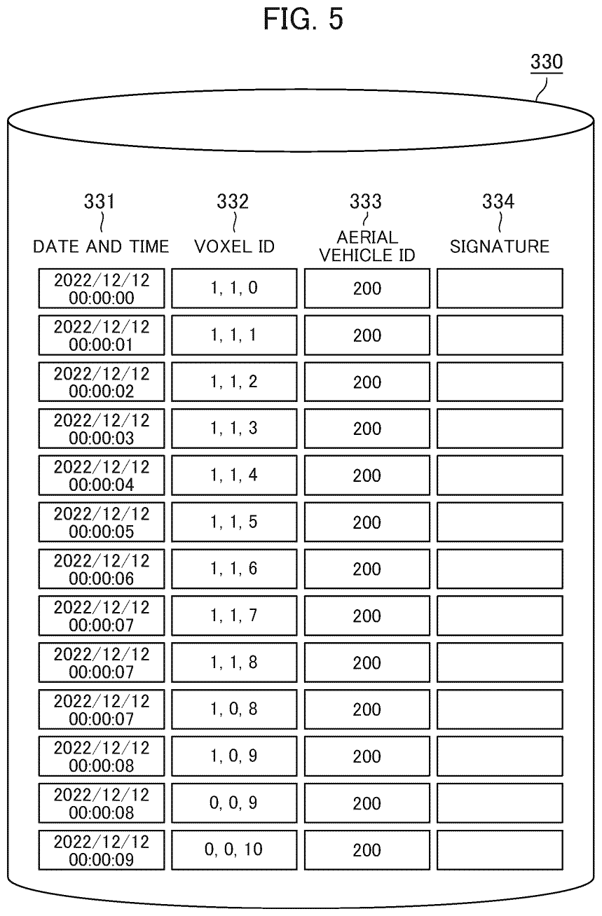

FIG. 5 illustrates the flight plan 330 according to the first embodiment. In FIG. 5, the flight plan 330 is represented as a set of voxels occupied by the aerial vehicle 200 at each time. Specifically, the flight plan 330 is represented as a set of a date and time 331, a voxel ID 332, an aerial vehicle ID 333, and an authentication signature 334. In other words, it is indicated that “aerial vehicle ID 333” occupies “voxel ID 332” at “date and time 331”. It is assumed that a voxel is represented by the X, Y, and Z coordinates of the voxel.

Furthermore, the example in FIG. 5 illustrates that the aerial vehicle 200 will occupy voxels (1, 1, 0), (1, 1, 1), (1, 1, 2), (1, 1, 3), (1, 1, 4), (1, 1, 5), (1, 1, 6), (1, 1, 7), (1, 1, 8), (1, 0, 8), (1, 0, 9), (0, 0, 9), and (0, 0, 10) as time progresses from 2022/12/12 00:00:00 to 2022/12/12 00:00:09. In other words, the aerial vehicle 200 flies along a flight route indicated by a set of these voxels. Note that at times 2022/12/12 00:00:07 and 2022/12/12 00:00:08, the aerial vehicle 200 occupies two adjacent voxels, namely (1, 1, 8) and (1, 0, 8), and voxels (1, 0, 9), and (0, 0, 9), respectively. This means that the occupation of the voxels by the aerial vehicle 200 is spatially and temporally exclusive in order for aerial vehicles not to collide with each other. That is, this means that “date and time 331” and “voxel ID 332” must be assigned to each aerial vehicle so as not to overlap. Note that occupation in this application means preventing other aerial vehicles from entering the corresponding voxels and/or adjacent voxels in order for the aerial vehicle 200 to pass through the corresponding voxels. As described above, in the first embodiment, a voxel is used as an example of a unit airspace. This concludes the description of the first embodiment.

### Second Embodiment

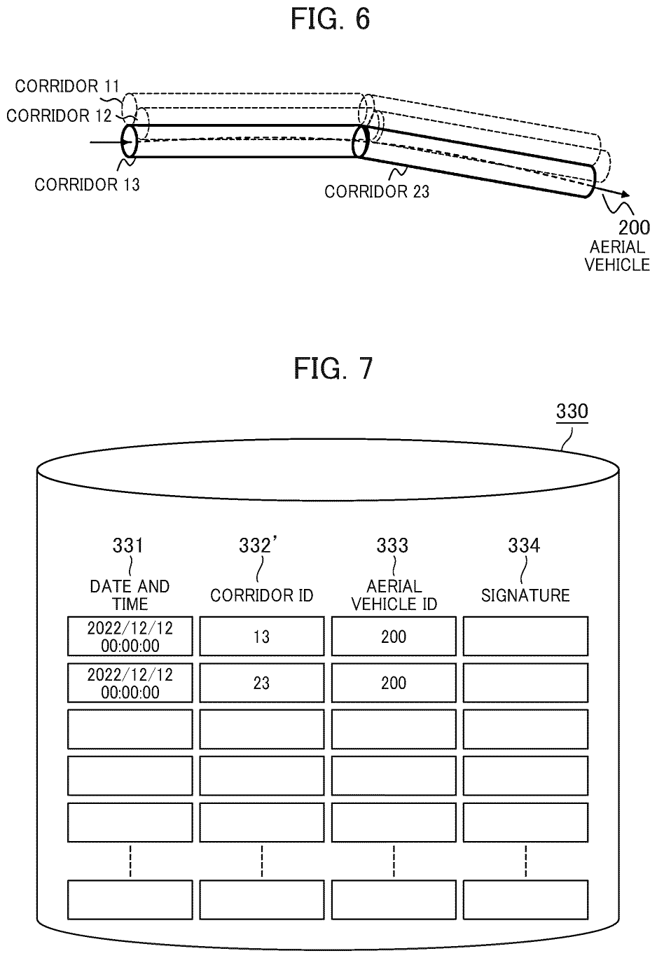

In the first embodiment, the flight route is created as a set of voxels, but in a second embodiment, the flight route is created as a set of corridors (air corridors). FIG. 6 illustrates an airspace divided by corridors and its flight route according to the second embodiment. As illustrated in FIG. 6, the aerial vehicle 200 flies from left to right in the drawing. That is, the aerial vehicle 200 flies from a corridor 13 through a corridor 23.

Furthermore, in the second embodiment, the aerial vehicle control device 100 creates the flight plan 330 and controls the aerial vehicle 200 according to the flowchart illustrated in FIG. 4, as in the first embodiment. However, corridors are used instead of voxels in steps S4 and S5.

As a result, in the second embodiment, the flight plan 330 illustrated in FIG. 7 is created. As illustrated in FIG. 7, the flight plan 330 according to the second embodiment is represented as a set of the date and time 331, a corridor ID 332′, the aerial vehicle ID 333, and the authentication signature 334. In other words, it is indicated that “aerial vehicle ID 333” occupies “corridor ID 332′” at “date and time 331”. In addition, the present embodiment illustrates that the aerial vehicle 200 occupies the corridor 13 at 2022/12/12 00:00:00 and occupies the corridor 23 at 2022/12/12 00:00:10.

Note that in the second embodiment, the flight plan confirmation unit 120 writes the authentication signature 334 every time the flight plan 330 is created or updated, if “date and time 331” and “voxel ID 332”, or “date and time 331” and “corridor ID 332′” do not overlap. Here, “not overlapping” means that they are not assigned to a plurality of the aerial vehicle IDs 333. The flight plan confirmation unit 120 may use a specific code as the authentication signature 334, or may generate the authentication signature 334 according to a sum check of information such as the date and time 331, corridor ID 332′, and aerial vehicle ID 333, or a predetermined generating polynomial.

As described above, the flight plan confirmation unit 120 can determine whether the flight plan is valid or not on the basis of whether the value of the authentication signature 334 matches or does not match the expected value given from the information such as the date and time 331, the corridor ID 332′, and the aerial vehicle ID 333. If the flight plan is valid as a result of this determination, the flight plan confirmation unit 120 may confirm that the flight plan 330 has been approved. Note that this processing can also be applied to the first embodiment. In this case, the flight plan confirmation unit 120 uses the voxel ID 332 instead of the corridor ID 332′.

Furthermore, as described above, the guidance control unit 130 uses the flight plan 330 to control the flight of the aerial vehicle 200. Specifically, the guidance control unit 130 creates control signals in accordance with the date and time 331, corridor ID 332′, and aerial vehicle ID 333 registered in the flight plan 330. Then the guidance control unit 130 outputs the control signals to the aerial vehicle 200. In addition, the guidance control unit 130 desirably creates and outputs corrective control signals when there is a risk of deviation from the flight route included in the flight plan 330. Note that this processing can also be applied to the first embodiment. In this case, the guidance control unit 130 uses the voxel ID 332 instead of the corridor ID 332′.

This concludes the description of the second embodiment, but the first and second embodiments can be combined. In other words, voxels and corridors, which are unit airspaces, can be used together. For example, the aerial vehicle control device 100 can create flight routes and control flights by representing the airspace near airports or near flight route junctions as voxels such as illustrated in FIG. 3, and the flight routes connecting them as corridors, as illustrated in FIG. 6. In this case, it is assumed that the aerial vehicle control device 100 will share the voxel ID 332 and corridor ID 332′ fields in the flight plan 330 and add an identifier indicating whether the ID indicates the voxel or corridor that is the unit airspace. For example, “V” is prefixed for the voxel ID and “C” for the corridor ID. As described above, in the second embodiment, a corridor is used as an example of a unit airspace.

### Third Embodiment

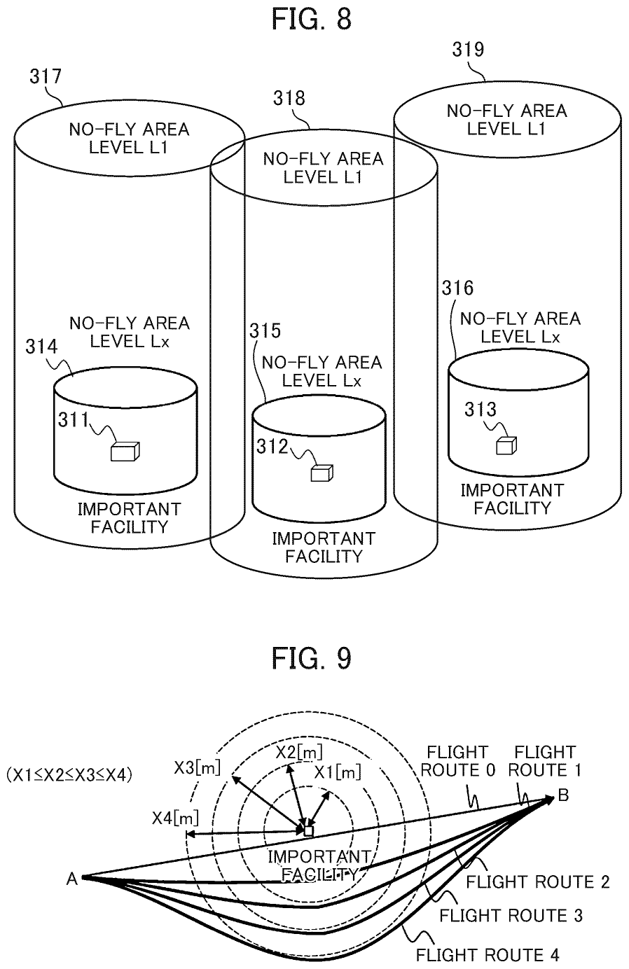

Next, an example of the flyable area information 310 will be described as a third embodiment. FIG. 8 is a schematic diagram of the flyable area information 310 according to the third embodiment. FIG. 8 illustrates that the information is composed of the coordinates of important facilities 311, 312, and 313 on the airspace map as well as the coordinates of their corresponding no-fly areas (317, 318, and 319) at level L1 to no-fly areas (314, 315, and 316) at level Lx. Note that the coordinates of the no-fly areas (317, 318, 319) at level L1 to the no-fly areas (314, 315, 316) at level Lx may be represented as a set of voxel IDs.

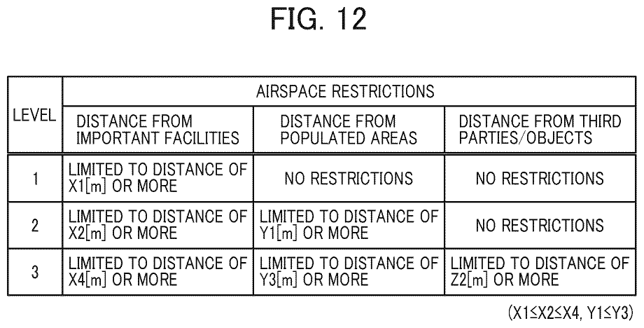

The above is an example in which no-fly areas are set in advance on an airspace map. However, the flyable area information 310 may be created by generating no-fly areas (coordinates) for each level from airspace regulation information, such as those illustrated in FIGS. 12, 14, and 25, which will be described later, based on coordinate information of important facilities or the like on the airspace map. Note that the flyable area information 310 may be created by the flight planning unit 110, or may be created by another device or by manual input by the user.

Here, the idea of identifying the flight route using the flyable area information 310 (step S5 in FIG. 4) will be described. FIG. 9 illustrates a procedure for identifying a flight route using the flyable area information 310 according to the third embodiment. In FIG. 9, the aerial vehicle 200 flies from point A to point B. This is included in the flight-related information. In this case, the flight route must be such that a predetermined distance (X1 to X4[m], where X1<X2<X3<X4) is placed between the aerial vehicle 200 and important facilities or the like between points A and B, depending on the flight continuation level.

Therefore, the flight planning unit 110 selects flight routes 4, 3, 2, and 1 in order of low to high flight continuation levels. Therefore, when flying from point A to point B, the aerial vehicle 200 with a high flight continuation level can fly a shorter flight route. In other words, the flight planning unit 110 identifies flight routes with small numerical values, such as flight routes 0 and 1 in the figure, as flight routes for the aerial vehicle 200 with a high flight continuation level. Here, the aerial vehicle control device 100 may be configured to display the contents of FIG. 9 via the output unit. In particular, the flight route 0 (including flights for maintenance and inspection) over important facilities or the like is selected only in cases where the flight continuation level is extremely high, the failure rate is low, and the security level is high. It should be noted that this flight route procedure can also be applied to other embodiments.

### Fourth Embodiment

Next, as a fourth embodiment, an example of the case where the flight continuation level information 320 has three or more flight continuation levels will be described. By setting the flight continuation level in this manner, cases that become conditionally possible between flight possible and impossible arise, leaving room for optimization under conditions that become possible. Therefore, in the present embodiment, the flight continuation level in the flight continuation level information 320 is set to three or more levels (Level 3, Level 4, and Level 5).

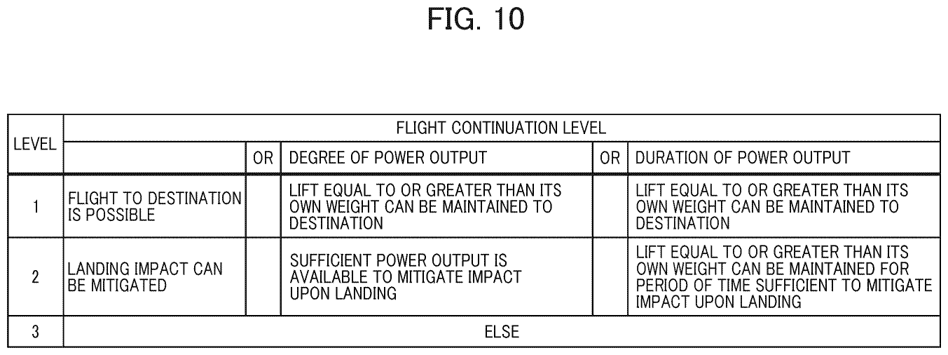

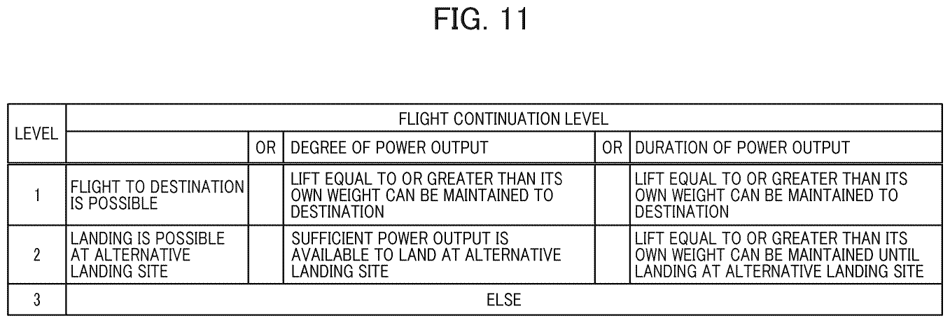

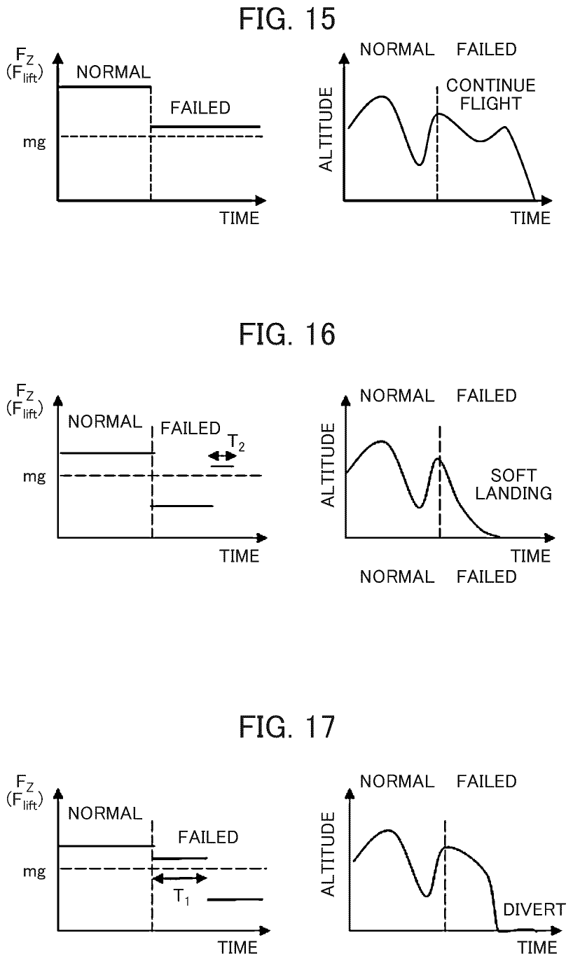

FIGS. 10 and 11 illustrate the flight continuation level information 320 with three flight continuation levels according to the fourth embodiment. First, FIG. 10 illustrates flight continuation level information 320, with Level 1 as a flight continuation level at which flight to a destination is possible, Level 2 as a flight continuation level at which landing impact can be mitigated, and Level 3 as a flight continuation level that does not fall under any of the above. Among these, Level 1, “flight continuation level at which flight to a destination is possible” is the level at which it is possible to maintain lift equal to or greater than its own weight to the destination, as illustrated in FIG. 15, when represented in terms of the degree and duration of power output of the aerial vehicle 200. In order to achieve this Level 1, redundancy is required for the aerial vehicle 200 in preparation for failures of a propulsion mechanism or a mechanism that generates lift. Note that FIG. 15 is a first graph illustrating the relationship between lift and failure occurrence, as well as the possibility of continued flight, according to the fourth embodiment.

In addition, Level 2, “flight continuation level at which landing impact can be mitigated” indicates a level at which “sufficient power output is available to mitigate landing impact”, as illustrated in FIGS. 16 and 19. Here, FIGS. 16 and 19 are second graphs illustrating the relationship between lift and failure occurrence, as well as the possibility of continued flight, according to the fourth embodiment. First, when represented in terms of the degree of power output of the aerial vehicle 200, this is the level at which “sufficient power output is available to mitigate landing impact” as illustrated in FIG. 19. Note that “capable of mitigating impact” here means not only preventing damage to the aerial vehicle 200 itself, but also preventing damage to buildings, structures, people, etc. on the ground. For example, this can be achieved by the autorotation descent of a helicopter, which is one type of the aerial vehicle 200, or by mitigating the fall velocity by the drag of a parachute or the like provided on the aerial vehicle 200. Furthermore, in an electric aerial vehicle, which is one type of the aerial vehicle 200, it is not possible to generate lift sufficient to support the freedom of the electric aerial vehicle, but it is required to be able to generate lift sufficient to reduce the descent rate.

In addition, when represented in terms of the duration of power output, Level 2 above is a level at which “it is possible to maintain lift equal to or greater than its own weight for a period of time sufficient to mitigate landing impact” as illustrated in FIG. 16. This includes, for example, applying collective flare (increasing the pitch of the rotor blades to convert the rotational energy of the rotor blades into lift) at the moment of landing during the autorotation descent of a helicopter, which is one type of the aerial vehicle 200. It also includes inflating airbags under the airframe of the aerial vehicle 200 to absorb and mitigate landing impact.

Further, in the case of an electric aerial vehicle, which is another type of the aerial vehicle 200, with regard to Level 2, it is not possible to generate lift sufficient to support the freedom of the aerial vehicle for a long period of time. However, it is required to be able to generate lift sufficient to reduce the descent rate in a short period of time at the moment of landing.

Note that Level 3 is a flight continuation level that does not fall under either Level 1 or 2. This will be described later in the explanation of FIG. 11.

Next, the flight continuation level information 320 illustrated in FIG. 11 will be described. In the flight continuation level information 320 illustrated in FIG. 11, Level 1 is set as a flight continuation level at which flight to a destination is possible, Level 2 as a flight continuation level at which landing at an alternative landing site is possible, and Level 3 as a flight continuation level that does not fall under any of the above. Level 2 illustrated in FIG. 11, when represented in terms of the degree of power output, indicates that sufficient power output is available to land at an alternative landing site. In addition, when represented in terms of the duration of power output, this is the level at which it is possible to maintain lift equal to or greater than its own weight until landing at an alternative landing site, as illustrated in FIG. 17. Here, FIG. 17 is a third graph illustrating the relationship between lift and failure occurrence, as well as the possibility of continued flight, according to the fourth embodiment.

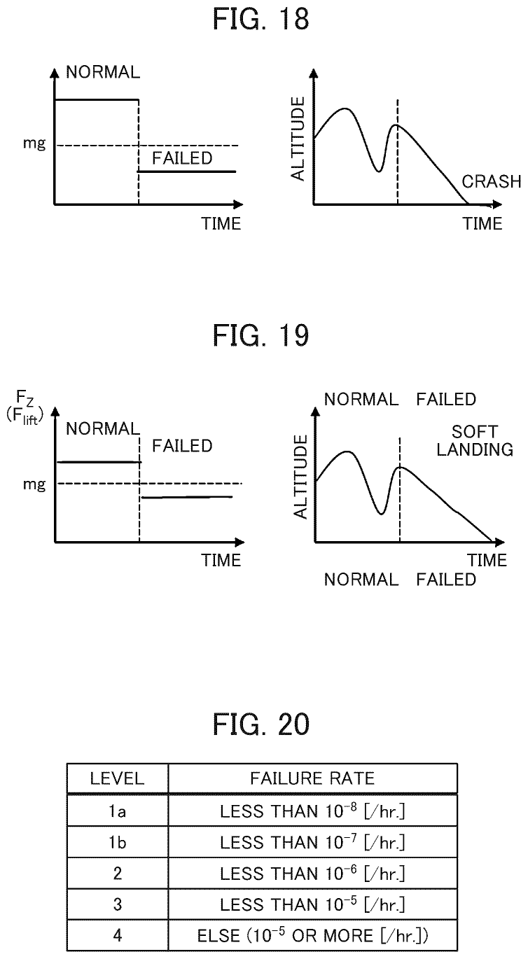

Furthermore, Level 3 is a flight continuation level that does not fall under either Level 1 or 2. Level 3 is a level at which it is not possible to generate lift equal to or greater than its own weight after a failure occurs, as illustrated in FIG. 18. Note that here, FIG. 18 is a fourth graph illustrating the relationship between lift and failure occurrence, as well as the possibility of continued flight, according to the fourth embodiment.

In addition, the flight continuation level is associated with the restriction level of the airspace. That is, the restriction level according to the fourth embodiment is set to three levels, similar to the flight continuation level. The restriction levels according to the fourth embodiment will be described below. FIG. 12 illustrates the flyable area information 310 with three airspace restriction levels according to the fourth embodiment.

In FIG. 12, restriction level 1 corresponds to Level 1 of the flight continuation level. In addition, the restriction level 1, as a flight restriction, permits flight only at a distance of x1[m] or more from important facilities, and there are no restrictions on the distance from populated areas and from third parties or objects.

Furthermore, in FIG. 12, restriction level 2 corresponds to the flight continuation level (Level 2) at which landing at an alternative landing site is possible or landing impact can be mitigated. In this case, this flight restriction permits flight only at a distance of x2[m] or more from important facilities and at a distance of y1[m] or more from populated areas, and there are no restrictions on the distance from third parties or objects.

Further, restriction level 3, which satisfies none of the above, indicates that flight is permitted only at a distance of x4[m] or more from important facilities, at a distance of y3[m] or more from populated areas, and at a distance of z2[m] or more from third persons or objects. It should be noted that under the current law in Japan, restrictions on airspace are not classified into levels as in the present embodiment, and it is believed that all are classified as the lowest restriction level 3. In this case, x4=300 m (Small Unmanned Aircraft Prohibition Act) and z2=30 m (Aviation Act) are regulated. The horizontal distance to be maintained has been described above, but the vertical and height distances to be maintained can also be determined for each restriction level in the same manner.

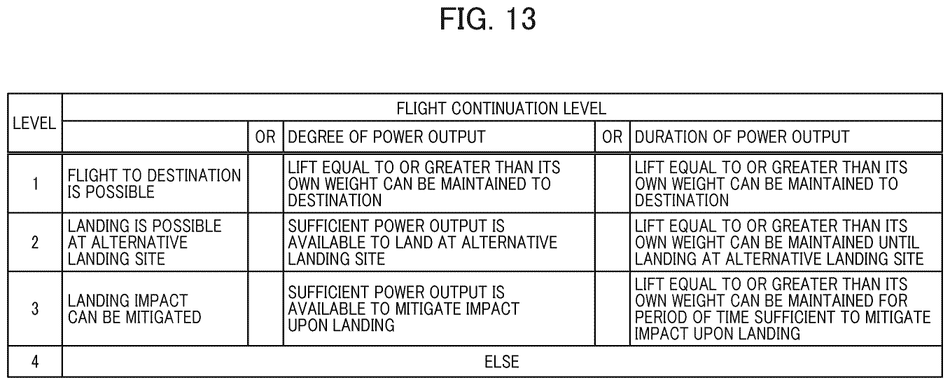

Next, an example in which the flight continuation level information 320 has four flight continuation levels will be described. FIG. 13 illustrates the flight continuation level information 320 with four flight continuation levels according to the fourth embodiment. In FIG. 13, Level 1 is set as a flight continuation level at which flight to a destination is possible, Level 2 as a flight continuation level at which landing at an alternative landing site is possible, Level 3 as a flight continuation level at which landing impact can be mitigated, and Level 4 as a flight continuation level that does not fall under any of the above. In addition, the flyable area information 310 with four restriction levels set so as to correspond to this flight continuation level information 320 is used.

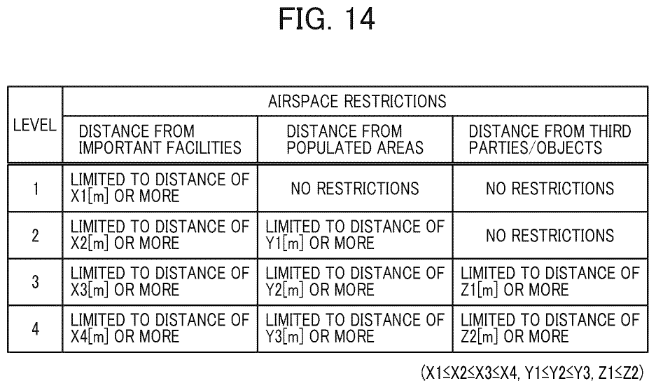

FIG. 14 illustrates the flyable area information 310 with four airspace restriction levels according to the fourth embodiment. In FIG. 14, flight restrictions at restriction level 1 permit flight only at a distance of x1[m] or more from important facilities, and there are no restrictions on the distance from populated areas and from third parties or objects.

Furthermore, flight restrictions at restriction level 2 permit flight only at a distance of x2[m] or more from important facilities and at a distance of y1[m] or more from populated areas, and there are no restrictions on the distance from third parties or objects. Moreover, flight restrictions at restriction level 3 indicate that flight is permitted only at a distance of x4[m] or more from important facilities, at a distance of y2[m] or more from populated areas, and at a distance of z1[m] or more from third persons or objects. Further, flight restrictions at restriction level 4, which satisfies none of the above, indicate that flight is permitted only at a distance of x4[m] or more from important facilities, at a distance of y3[m] or more from populated areas, and at a distance of z2[m] or more from third persons or objects.

### Fifth Embodiment

Next, a fifth embodiment will be described, in which a flight continuation level according to a failure rate is used. FIG. 20 illustrates the flight continuation level information 320, which indicates flight continuation levels according to the failure rates in the airframe of the aerial vehicle 200 in a fifth embodiment. Furthermore, in the fifth embodiment, the flight continuation level information 320 indicating five flight continuation levels is used. Therefore, the use of failure rate is merely one example, and flight capabilities other than the failure rate may be used. Note that in FIG. 20, Levels 1a, 1b, 2, and 3 correspond to Safety Integrity Levels (SIL) 4, 3, 2, and 1, respectively, as defined in the functional safety standard (IEC 61508). That is, it is illustrated that, from Level 1a to Level 4, the failure rate increases, and as a result, the flight capability decreases in the same order. Note that in the present embodiment, the flyable area information 310 indicating the restriction levels according to these levels 1a to 4 is used.

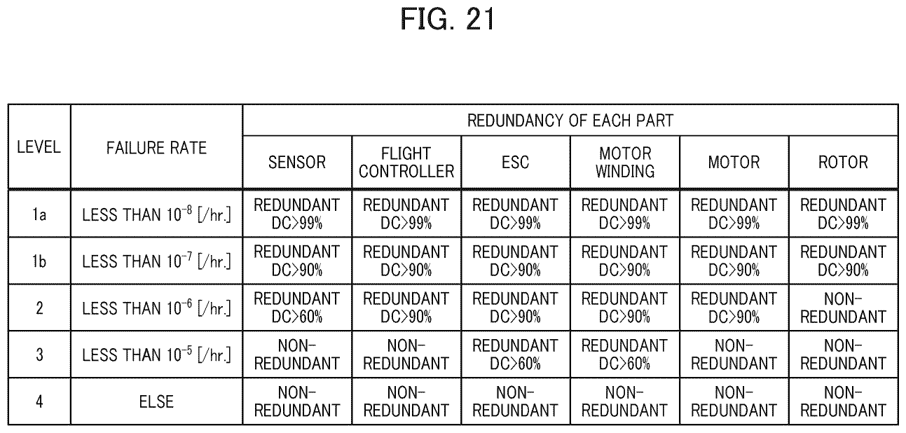

Next, a modification of the fifth embodiment using a flight continuation level according to the redundancy of the aerial vehicle 200 will be described. FIG. 21 illustrates the flight continuation level information 320, which indicates flight continuation levels according to the redundancies in each part of the aerial vehicle 200 in the fifth embodiment. In FIG. 21, the failure rate of the airframe of the aerial vehicle 200 and the redundancy of each part (the components that constitute the aerial vehicle 200) are illustrated for each level. Here, parts constituting the aerial vehicle 200 include a sensor, a flight controller, an Electronic Speed Controller (ESC), a motor winding, a motor, and a rotor. In addition, the flight continuation level information 320 specifies, as the degree of redundancy of each part, either redundant or non-redundant, and if redundant, diagnosis coverage (DC). Note that in FIG. 21, a battery is not illustrated as a component of the aerial vehicle 200, but this redundancy may also be included in the flight continuation level information 320. Furthermore, FIG. 21 is an example of the flight continuation level information 320 according to the present embodiment, and the embodiment for achieving the required airframe reliability (low failure rate) is not limited to this.

Details of FIG. 21 will be described below. In FIG. 21, to achieve Level 1a, which is the highest level of safety, all components must be made redundant and a diagnostic coverage of over 99% is required. Additionally, to achieve a diagnostic coverage of over 99%, in addition to redundant flight controllers, the microprocessors that make up the individual flight controllers must also be made redundant or the like, thereby enabling self-checking.

To achieve Level 1b, which is the next highest level of safety, all components must be made redundant and a diagnostic coverage of over 90% is required. Furthermore, to achieve Level 2, each part except the rotor must be made redundant and a diagnostic coverage of over 90% is required. Note that the motor is redundantly mechanically connected to the rotation shaft of the non-redundant rotor.

Furthermore, to achieve Level 3, the ESC and motor windings must be made redundant and a diagnostic coverage of over 60% is required. Note that the non-redundant motor is equipped with redundant windings, each of which is driven by the redundant ESC. Also note that the sensors include a GPS receiver, and to achieve Level 1a, it is necessary not only to make the GPS receiver redundant, but also to provide other positioning sensors such as an inertial guidance system (INS). Also note that at Level 3, the GPS receiver does not need to be made redundant, but even in the event of GPS signal loss, it is possible to continue flight by using the Kalman filter or dead reckoning (odometric) functions.

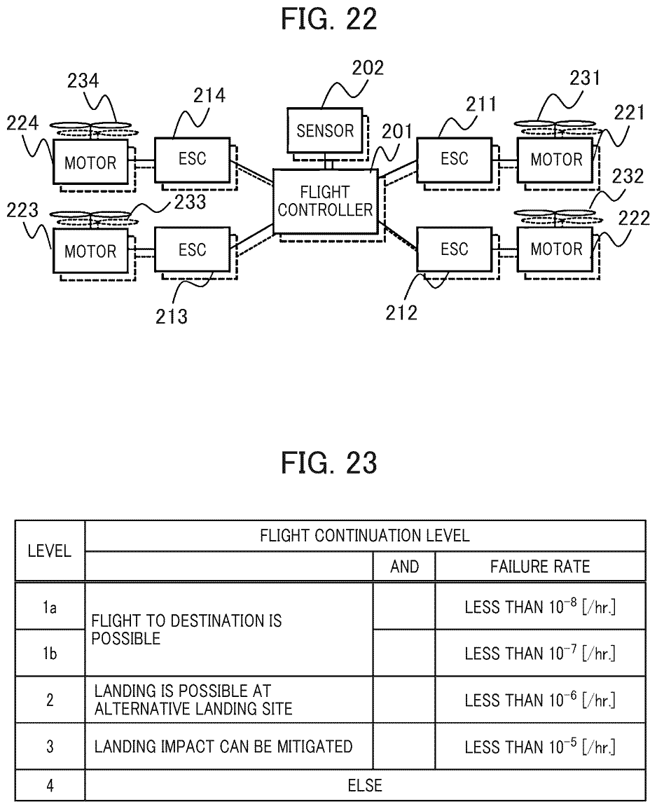

Next, the manner in which the aerial vehicle 200 is made redundant will be described. FIG. 22 illustrates the redundant aerial vehicle 200 according to the fifth embodiment. In FIG. 22, a four-rotor aerial vehicle 200 is illustrated as an example of the aerial vehicle 200. Note that if the rotors are made redundant, the four-rotor aerial vehicle 200 has eight rotors. As illustrated in FIG. 21, depending on the level, there are some components that require redundancy and some that do not. For this reason, in FIG. 22, components that require redundancy at some levels are indicated by dashed lines.

Using a signal from a sensor 202 of the aerial vehicle 200 in FIG. 22, a flight controller 201 sends rotational speed commands to ESCs 211 to 214, and the ESCs 211 to 214 control the current flowing through the motor windings in accordance with the rotational speed commands so as to achieve a predetermined rotational speed. In addition, rotors 231 to 244 are attached to the output shafts of motors 221 to 224, and the rotation of the motors 221 to 224 rotates the rotors 231 to 244 to generate lift. Note that in the aerial vehicle 200 equipped with a plurality of rotors, the rotors do not have a function for controlling pitch, and the attitude and flight direction are controlled by controlling the rotational speed of each rotor.

Here, a GPS receiver, an attitude sensor, or the like can be used as the sensor 202. In addition, the GPS receiver sends the current position of the aerial vehicle 200 to the flight controller 201, and the flight controller 201 controls the rotors 231 to 244 so that the aerial vehicle 200 flies according to the flight route in the flight plan. Further, the attitude sensor also sends attitude information of the aerial vehicle 200 to the flight controller 201, and the flight controller 201 controls the rotors 231 to 244 so that the aerial vehicle 200 maintains a predetermined attitude suitable for flight.

Next, another example of the flight continuation level information 320 will be described. FIG. 23 illustrates the flight continuation level information 320, which indicates flight continuation levels according to the flight capabilities and failure rates in the airframe of the aerial vehicle 200 in the fifth embodiment. In FIG. 23, the flight continuation level is the flight continuation level information 320 obtained by adding airframe failure rate conditions to the flight continuation level information 320 in FIG. 20.

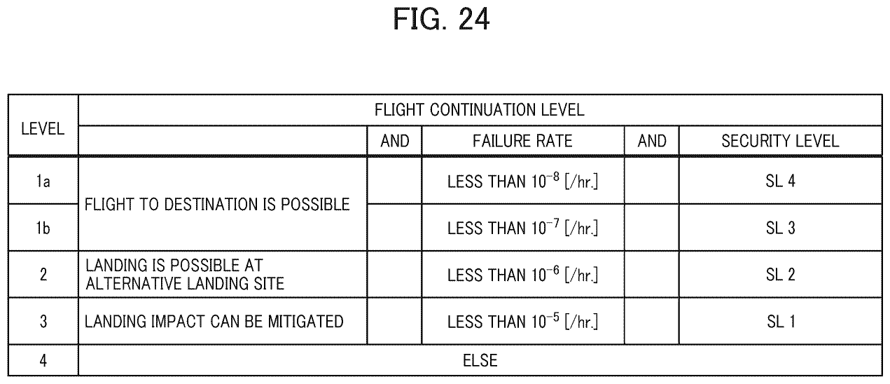

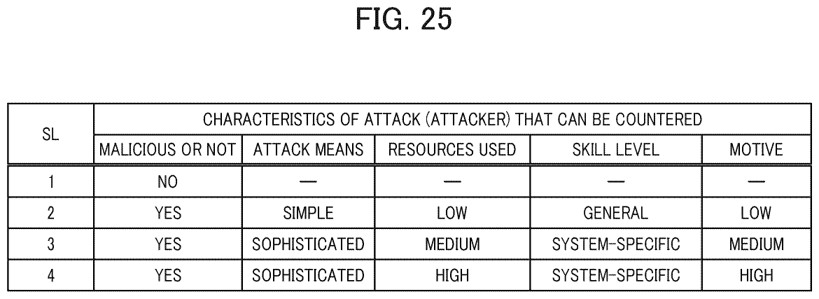

Furthermore, FIG. 24 illustrates the flight continuation level information 320, which indicates flight continuation levels according to the flight capabilities, failure rates, and security levels in the airframe of the aerial vehicle 200 in the fifth embodiment. In other words, FIG. 23 is the flight continuation level information 320 obtained by adding security level conditions to the flight continuation level information 320 in FIG. 22. Here, SL 1 to 4 can be used as the security level (SL) in the international standard IEC62443-3-3 for control system security. In this case, the security level table illustrated in FIG. 25 can be used. FIG. 25 illustrates a security level table according to the fifth embodiment. In FIG. 25, the security level table classifies the characteristics of attacks (attackers) that can be countered for each SL.

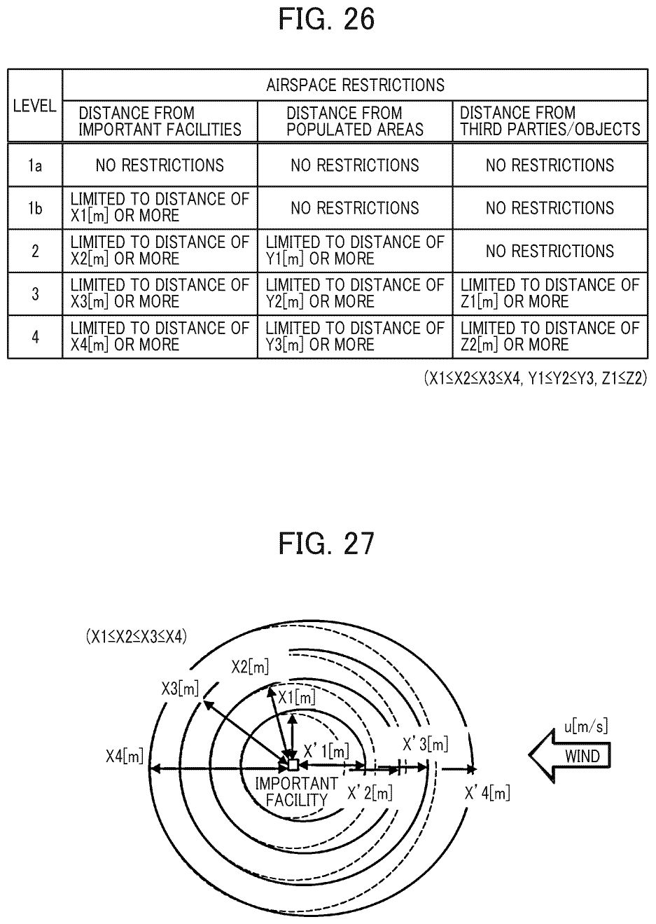

Next, the flyable area information 310 according to the fifth embodiment, that is, the flyable area information 310 associated with the flight continuation level information described above, will be described. FIG. 26 illustrates the flyable area information 310 according to the fifth embodiment.

In FIG. 26, the flyable area information 310 shows airspace restrictions, which are the contents of restrictions on the positional conditions of the airspace, for each of the five restriction levels set so as to correspond to the flight continuation level information 320 described above.

Specifically, in FIG. 26, as a restriction on airspace, the distance from important facilities or the like that serve as bases is specified as positional conditions.

The following describes the airspace restrictions when using the flight continuation level information 320 illustrated in FIG. 23 and the flyable area information 310 illustrated in FIG. 26. In the case of flight continuation level 1a, where flight to a destination is possible and the airframe failure rate is less than 10⁻⁸ [per hour], there are no flight restrictions. Furthermore, in the case of flight continuation level 1b, where flight to a destination is possible and the airframe failure rate is less than 10⁻⁷ [per hour], flight restrictions permit flight only at a distance of x1[m] or more from important facilities, and there are no restrictions on the distance from populated areas and from third persons or third objects.

Moreover, in the case of flight continuation level 2, where landing at an alternative landing site is possible and the airframe failure rate is less than 10⁻⁶ [per hour], flight restrictions permit flight only at a distance of x2[m] or more from important facilities and at a distance of y1[m] or more from populated areas, and there are no restrictions on the distance from third parties or objects. Additionally, in the case of flight continuation level 3, where landing impact can be mitigated and the airframe failure rate is less than 10⁻⁵ [per hour], flight restrictions permit flight only at a distance of x3[m] or more from important facilities, at a distance of y2[m] or more from populated areas, and at a distance of z1[m] or more from third persons or objects. In the case of flight continuation level 4 that satisfies none of the above, for an airframe failure rate, flight is permitted only at a distance of x4[m] or more from important facilities, at a distance of y3[m] or more from populated areas, and at a distance of z2[m] or more from third persons or objects.

Next, airspace restrictions using the flight continuation level information 320 illustrated in FIG. 24 and the flyable area information 310 illustrated in FIG. 26 will be described. Especially in the vicinity of important facilities, the aerial vehicle could be hijacked by a cyber attack, which could lead to a terrorist attack. For this reason, the security level of the remote control function of the aerial vehicle 200 and positioning sensors, such as GPS receivers, as specified by the flight continuation level information 320 illustrated in FIG. 24, becomes a particularly important indicator.

In the case of flight continuation level 1a, if flight to a destination is possible, the airframe failure rate is less than 10⁻⁸ [per hour], and the security level is SL4, there are no flight restrictions. Furthermore, in the case of flight continuation level 1b, if flight to a destination is possible, the airframe failure rate is less than 10⁻⁷ [per hour], and the security level is SL3, the following flight restrictions apply. The flight restrictions permit flight only at a distance of x1[m] or more from important facilities, and there are no restrictions on the distance from populated areas and from third parties or objects.

Moreover, in the case of flight continuation level 2, if landing at an alternative landing site is possible, the airframe failure rate is less than 10⁻⁶ [per hour], and the security level is SL2, the following flight restrictions apply. The flight restrictions permit flight only at a distance of x2[m] or more from important facilities and at a distance of y1[m] or more from populated areas, and there are no restrictions on the distance from third parties or objects.

Additionally, in the case of flight continuation level 3, if landing impact can be mitigated, the airframe failure rate is less than 10⁻⁵ [per hour], and the security level is SL1, the following flight restrictions apply. The flight restrictions permit flight only at a distance of x3[m] or more from important facilities, at a distance of y2[m] or more from populated areas, and at a distance of z1[m] or more from third persons or objects. In the case of flight continuation level 4 that satisfies none of the above, flight is permitted only at a distance of x4[m] or more from important facilities, at a distance of y3[m] or more from populated areas, and at a distance of z2[m] or more from third persons or objects. This concludes the description of the fifth embodiment.

### Sixth Embodiment

Next, a sixth embodiment will be described, which uses the flight continuation level information 320 that takes into account the effects of wind, which is an example of a weather condition, and the airframe weight of the aerial vehicle 200. FIG. 27 illustrates the concept of the flight continuation level information 320 taking into account the effects of wind according to the sixth embodiment. In FIG. 27, the distances to be maintained from important facilities or the like are in the form of concentric circles for each flight continuation level when there is no wind. However, when there is wind, it is sufficient to take into account that the aerial vehicle will be blown away by the wind, and to maintain a greater distance upwind (for example, X′=X+Ku, u: wind speed, K: proportionality coefficient). In other words, the concentric circles change from the dashed lines in FIG. 27 to the solid lines.

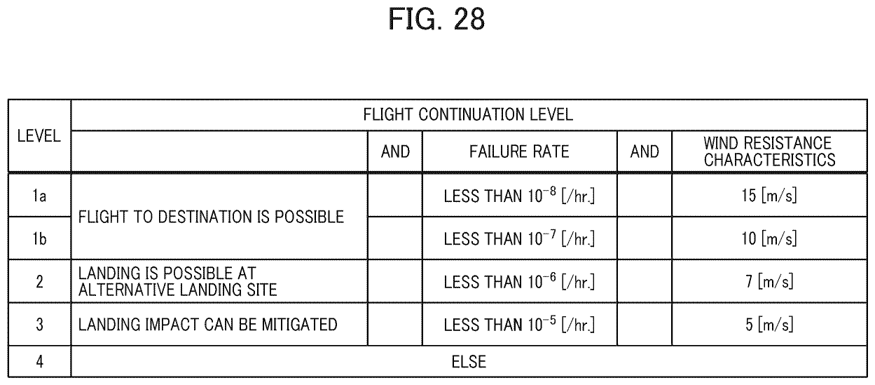

Here, FIG. 28 illustrates the flight continuation level information 320 taking into account the effects of wind according to the sixth embodiment. In the present embodiment, the wind resistance characteristics (steady wind, gusty wind) of the aerial vehicle 200 are used as the flight capability to reflect the effects of wind. A security level may be added. A security level may also be added to this flight continuation level information 320.

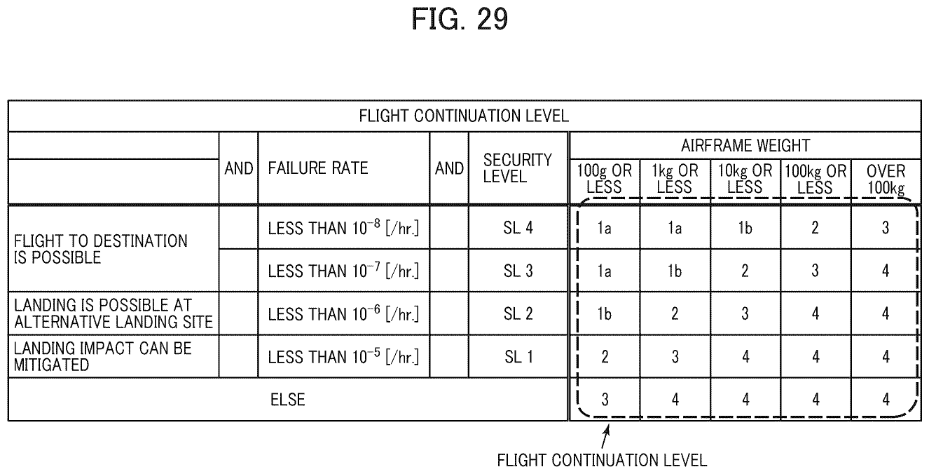

Next, FIG. 29 illustrates the flight continuation level information 320 taking into account the airframe weight of the aerial vehicle 200 according to the sixth embodiment. The heavier the airframe, the greater the damage in the event of a collision with another object. For this reason, as illustrated in FIG. 28, the heavier the airframe is, the stricter flight restrictions are imposed in the flight continuation level information 320 according to the sixth embodiment. In the figure, 1a, 1b, 2, . . . 4 illustrated below the airframe weight column indicate the flight continuation level. This concludes the description of the sixth embodiment.

### Seventh Embodiment

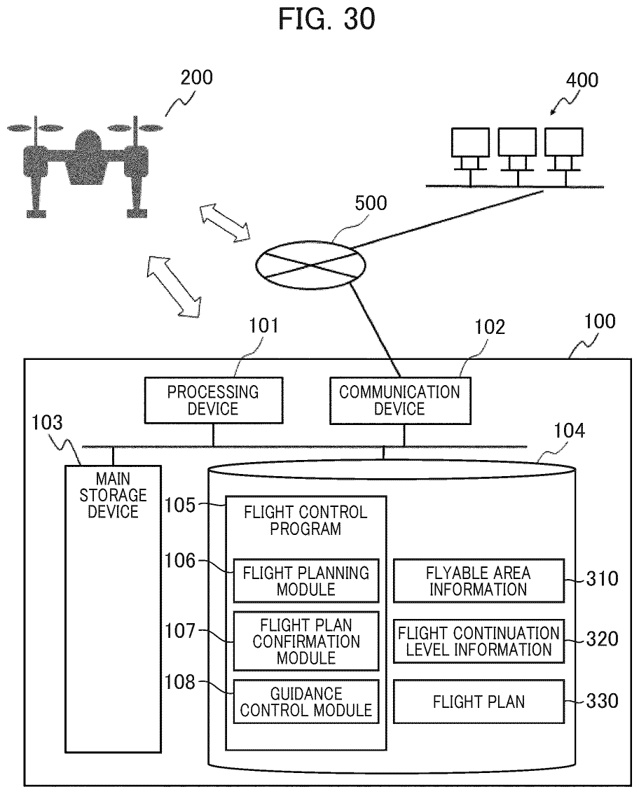

Next, a seventh embodiment in which the aerial vehicle control device 100 is implemented as a computer will be described. FIG. 30 is a system configuration diagram of an aerial vehicle control system including an implementation example of the aerial vehicle control device 100 according to the seventh embodiment. In FIG. 30, the aerial vehicle control device 100 is connected to the aerial vehicle 200 and a group of terminal devices 400 via a network 500. Therefore, the aerial vehicle control device 100 can be implemented on a server, also known as a cloud or in-house system, among computers. FIG. 30 also illustrates the hardware configuration of the aerial vehicle control device 100. In other words, the aerial vehicle control device 100 has a processing device 101, a communication device 102, a memory 103, and a secondary storage device 104, which are connected to each other via communication paths.

First, the processing device 101 can be implemented by a processor such as a Central Processing Unit (CPU), and executes calculations according to a flight control program 105 stored in the secondary storage device 104, which will be described later.

Furthermore, the communication device 102 has an interface function with other devices. That is, the communication device 102 accepts input from users of the group of terminal devices 400 and outputs contents to be displayed on the group of terminal devices 400. In this case, the group of terminal devices 400 and the communication device 102 have the functions of the input unit and output unit described above. In addition, the communication device 102 communicates with the aerial vehicle 200 via the network 500 or directly. More specifically, the communication device 102 outputs a control signal to the aerial vehicle 200 in accordance with the calculations of the processing device 101.

In addition, the communication device 102 receives flight status (including flight route and flight attitude) from the aerial vehicle 200.

Moreover, the memory 103 and the secondary storage device 104 correspond to the above-mentioned storage unit. In addition, in the memory 103, the flight control program 105 stored in the secondary storage device 104 and information used for processing by the processing device 101 are expanded. Furthermore, the secondary storage device 104 can be implemented by a so-called storage. In addition, the secondary storage device 104 stores the flight control program 105, the flyable area information 310, the flight continuation level information 320, and the flight plan 330. Further, the secondary storage device 104 desirably stores other information described above, such as flight-related information. Furthermore, the secondary storage device 104 can be implemented by various storage media such as an external hard disk drive (HDD), solid state drive (SSD), or memory card.

Alternatively, the secondary storage device 104 may be implemented by a device separate from the aerial vehicle control device 100, such as a file server.

Here, the flight control program 105 is composed of a flight planning module 106, a flight plan confirmation module 107, and a guidance control module 108, for each function. Note that each of these modules may be implemented as an individual program or a partial combination. Furthermore, the aerial vehicle control device 100 may be implemented by a plurality of devices for each function. Further, the aerial vehicle control device 100 may also be referred to as a management device for the aerial vehicle 200.

Furthermore, the configuration illustrated in FIG. 2, which performs the same function as each module, is as follows.

Flight planning module 106: Flight planning unit 110 Flight plan confirmation module 107: Flight plan confirmation unit 120

### Guidance Control Module 108: Guidance Control Unit 130

Therefore, the processing device 101 executes the processing of the flight planning unit 110, the flight plan confirmation unit 120, and the guidance control unit 130 in FIG. 2 in accordance with the flight control program 105. In addition, the flight control program 105 can be stored in a storage medium.

Furthermore, the group of terminal devices 400 is operated by users, and can be implemented by a computer. In addition, the group of terminal devices 400 has the functions of an input unit and an output unit as described above. Note that in the present embodiment, the group of terminal devices is used, but may be a single terminal device.

This concludes the description of each embodiment. In each embodiment, it is possible to balance the cost of high reliability with the benefits it brings, thereby improving efficiency and optimizing the cost-effectiveness ratio (for example, shortening the flight route depending on the “reliability rank” of the aerial vehicle). In other words, it is possible to balance the cost of high reliability with the benefits it bring, thereby improving efficiency and optimizing the cost-effectiveness ratio (for example, shortening the flight route depending on the “reliability rank” of the aerial vehicle).

Furthermore, the present invention is not limited to the above-described embodiments, but can be applied to various applications and modifications. In addition, the aerial vehicles 200 include manned aircraft in addition to so-called unmanned aerial vehicles (UAVs), and can be powered by engines or the like as well as electricity.

### LIST OF REFERENCE SIGNS

100: aerial vehicle control device
110: flight planning unit
120: flight plan confirmation unit
130: guidance control unit
200: aerial vehicle
310: flyable area information
320: flight continuation level information
330: flight plan

1. An aerial vehicle control device for controlling flight of an aerial vehicle, comprising:
a flight planning unit that
acquires flight-related information indicating conditions related to the flight of the aerial vehicle,
identifies a flight continuation level indicating a flight capability of the aerial vehicle according to the flight-related information,
identifies a restriction level for flight in an airspace corresponding to the flight continuation level,
identifies a flyable area that satisfies the restriction level, and
creates a flight plan including a flight route for the aerial vehicle, using the flyable area; and
a guidance control unit that controls the flight of the aerial vehicle using the flight plan.

2. The aerial vehicle control device according to claim 1, wherein
the flight planning unit extracts unit airspaces with a more relaxed restriction level than the restriction level, and identifies the flyable area comprised of the unit airspaces as a flyable area that satisfies the restriction level.

3. The aerial vehicle control device according to claim 1, wherein
the flight planning unit identifies a plurality of the flight routes in advance and selects a flight route corresponding to the aerial vehicle using the identified restriction level.

4. The aerial vehicle control device according to claim 3, wherein
if there is no flight route corresponding to the aerial vehicle among the plurality of flight routes, the flight planning unit identifies a new flight route corresponding to the aerial vehicle.

5. The aerial vehicle control device according to claim 1, wherein
the flight planning unit identifies the flight route for each flight of the aerial vehicle.

6. The aerial vehicle control device according to claim 1, wherein
the flight continuation level and the restriction level are each comprised of three or more levels.

7. An aerial vehicle control method for controlling flight of an aerial vehicle using an aerial vehicle control device, the method comprising:
with a flight planning unit,
acquiring flight-related information indicating conditions related to the flight of the aerial vehicle,
identifying a flight continuation level indicating a flight capability of the aerial vehicle according to the flight-related information,
identifying a restriction level for flight in an airspace corresponding to the flight continuation level,
identifying a flyable area that satisfies the restriction level, and
creating a flight plan including a flight route for the aerial vehicle, using the flyable area; and
with a guidance control unit, controlling the flight of the aerial vehicle using the flight plan.

8. The aerial vehicle control method according to claim 7, wherein
unit airspaces with a more relaxed restriction level than the restriction level are extracted and the flyable area comprised of the unit airspaces is identified as a flyable area that satisfies the restriction level, by the flight planning unit.

9. The aerial vehicle control method according to claim 7, wherein
a plurality of the flight routes are identified in advance and a flight route corresponding to the aerial vehicle is selected using the identified restriction level, by the flight planning unit.

10. The aerial vehicle control method according to claim 9, wherein
if there is no flight route corresponding to the aerial vehicle among the plurality of flight routes, a new flight route corresponding to the aerial vehicle is identified by the flight planning unit.

11. The aerial vehicle control method according to claim 7, wherein
the flight route is identified for each flight of the aerial vehicle by the flight planning unit.

12. The aerial vehicle control method according to claim 7, wherein
the flight continuation level and the restriction level are each comprised of three or more levels.
